(19) United States
(12) Patent Application Publication
(10) Pub. No.: US 2014/0145818 A1
(43) Pub. Date: May 29, 2014

(54) THERMISTOR AND METHOD OF CONSTRUCTING A THERMISTOR

(71) Applicant: Amphenol Corporation, (unknown)

(72) Inventor: David John Geer, Johnsonburg, PA (US)

(73) Assignee: Amphenol Corporation

(21) Appl. No.: 13/685,982

(22) Filed: Nov. 27, 2012

(51) Int. Cl. H01C 17/242; H01C 7/00

(52) U.S. Cl. CPC H01C 17/242; H01C 7/008
USPC 338/22 SD; 427/58; 228/176; 427/554

(57) ABSTRACT

A method of constructing a thermistor includes forming a semiconductor ceramic substrate. The method also includes coating a surface of the substrate with contact material and applying a solder mask on the contact material. The applying includes applying the solder mask to one or more portions of the contact material to leave an exposed area without the solder mask and a masked area with the solder mask. The method includes trimming the contact material at the masked area to adjust a resistance of the thermistor.

### BACKGROUND OF THE INVENTION

The present invention relates to resistance trimming for thermistors and, more particularly, to automated resistance trimming after soldering.

A thermistor is a temperature-sensing element by virtue of the fact that it is a type of electrical component whose resistance varies with temperature. The thermistor comprises a semiconductor ceramic which is pressed, cast, molded, or otherwise formed into a substrate in the shape of a block or cylinder, for example. The thermistor may be formed of a polymer, as well. Contacts are added to the substrate. The thermistor undergoes thermal changes during the addition of the contacts. Thus, an aging process is typically undertaken to allow the resistance characteristic of the thermistor to stabilize. Leads are soldered to the contact surface, generally resulting in the solder covering the entire contact surface. While the process does not cause any problem with respect to physical connection of the leads to the contact, it can present other issues related to additional thermal changes and trimming requirements. With respect to thermal changes, the soldering process necessitates another aging process to stabilize the thermistor's resistance characteristics. With respect to trimming, if the resistance characteristics of the thermistor were exactly as needed at this stage, the process would be complete but more commonly, the resistance characteristics are not as needed. In such situations, trimming of the contact surface is needed to achieve the desired resistance value and tolerance requirements.

Trimming the contact surface (reducing contact size) to adjust the resistance (increase resistance value) has presented issues with regard to convenience and accuracy, among other factors. In one prior approach, resistance of the thermistor was adjusted by laser ablation of the contact surface prior to soldering the leads. However, since as noted above, thermal changes due to the soldering operation will affect resistance, laser ablation prior to soldering is somewhat inefficient with respect to the overall production of the thermistor. Another prior approach has involved adjusting the resistance value after the soldering process by using a manual grinding wheel to grind both the contact surface and bulk ceramic to adjust resistance and refine tolerance. However, this manual approach is time consuming and not readily automated. Finally, although laser ablation through the solder (rather than prior to the soldering process) has been considered, the varying depth of solder across the face of the contact surface makes this approach impracticable.

### BRIEF SUMMARY

According to an aspect of the invention, a method of constructing a thermistor includes forming a semiconductor ceramic substrate; coating a surface of the substrate with contact material; applying a solder mask on the contact material, the applying including applying the solder mask to one or more portions of the contact material to leave an exposed area without the solder mask and a masked area with the solder mask; and trimming the contact material at the masked area to adjust a resistance of the thermistor.

According to another aspect of the invention, a thermistor includes a ceramic substrate; a contact coating a surface of the ceramic substrate; and a solder mask covering a portion of the contact to form a masked area and an unmasked area on the contact.

### BRIEF DESCRIPTION OF THE DRAWINGS

Referring now to the drawings wherein like elements are numbered alike in the several Figures:

FIG. 1 depicts a thermistor according to an embodiment of the invention;

FIG. 2 depicts a thermistor according to an embodiment of the invention;

FIG. 3 is a block diagram of a system to trim thermistor resistance according to an embodiment of the invention;

FIG. 4 depicts aspects of a process to trim thermistor resistance according to an embodiment of the invention; and

FIGS. 5-7 illustrate exemplary solder mask areas according to embodiments of the invention.

### DETAILED DESCRIPTION

The method and system described in the embodiments herein address the issues, noted above, in trimming a thermistor to adjust resistance values. The following is a detailed description of one or more embodiments of the disclosed system and method presented herein by way of exemplification and not limitation with reference to the figures.

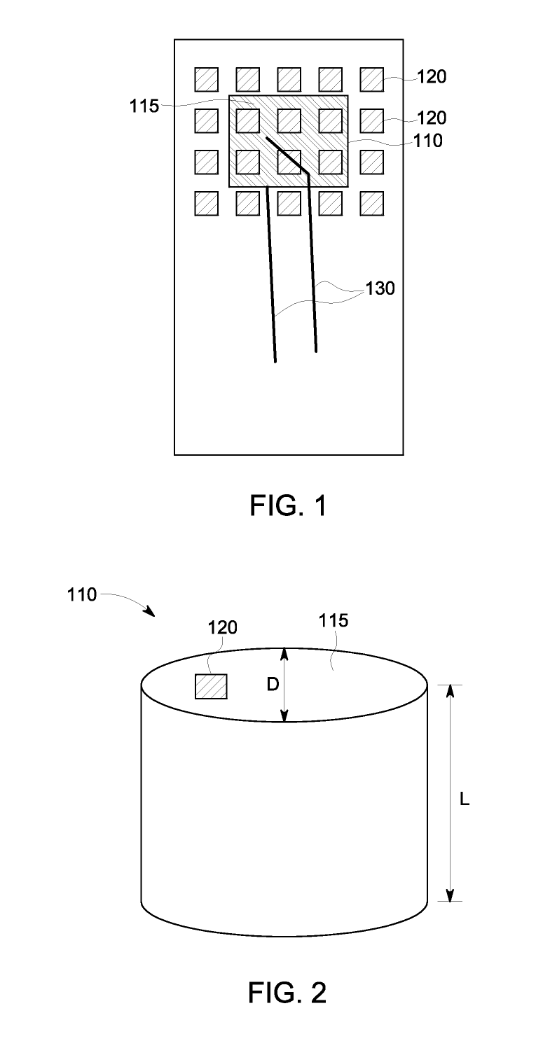

FIG. 1 depicts a thermistor 110 according to an embodiment of the invention. In the exemplary embodiment shown in FIG. 1, the thermistor 110 includes a ceramic block formed as a rectangular cube, for example, with the (rectangular) top (as illustrated in the figure, not necessarily always on top with respect to gravity) surface visible. The thermistor 110 has a contact 115 surface applied to one or both of the opposite ends of the exemplary cube shape, one shown and one not shown (at a bottom surface of the cube-shaped thermistor 110) in FIG. 1. The contact 115 is of a conductive material that may be a metal and in some embodiments may be silver or platinum, for example. Solder must be applied to the contact 115 to attach one or more leads 130 to the thermistor 110. According to embodiments of the invention, a solder mask 120 is applied over one or more portions of the contact 115. The solder mask 120 is a protective lacquer-like coating to which solder does not adhere. Thus, the thermistor 110 will have areas that are not covered by solder.

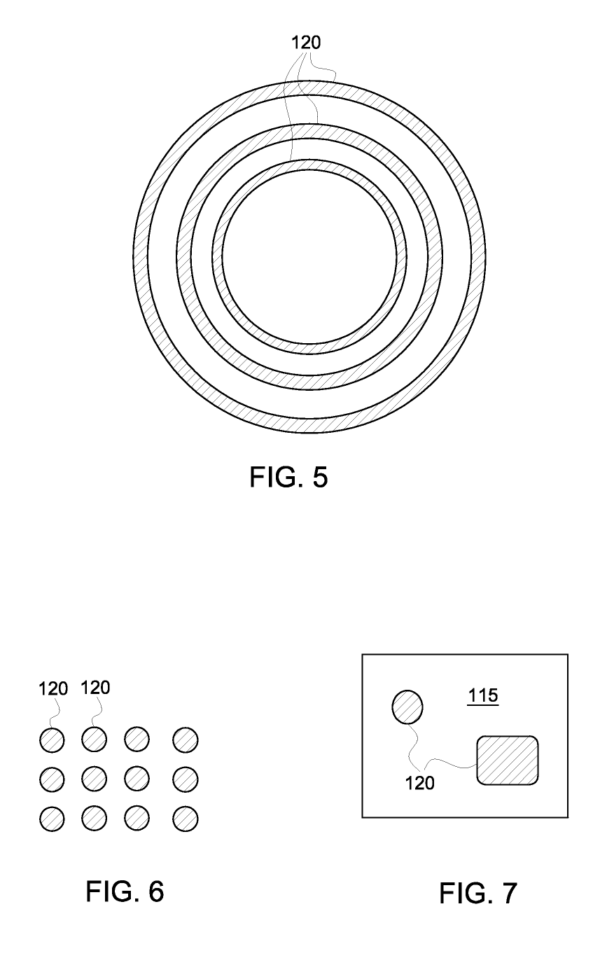

The solder mask 120 may be applied in a geometric pattern such as a square pattern, as shown in FIG. 1, which repeats across the contact 115. The solder mask 120 may instead be applied in a pattern of circles, concentric circles, or another shape or may be applied in one or more areas of the contact 115 but may not be in any pattern at all (see e.g., FIGS. 5-7). In the various embodiments, solder mask 120 sizes and patterns are contemplated that facilitate convenient modification of the resistivity characteristic. For example, a large number of small solder mask 120 areas as a pattern provide greater granularity of adjustment because a number of solder mask 120 areas may be selected for ablation based on the amount of resistivity adjustment needed. As another example, solder mask 120 areas of different sizes may facilitate greater accuracy in achieving the desired final resistivity characteristic for the thermistor 110. The exposed areas of the contact 115 (areas without the solder mask 120 applied) will facilitate soldering of the leads 130 to the thermistor 110. After soldering, the thermistor 110 may be aged to stabilize the resistance characteristics. Because the areas with the solder mask 120 do not have solder over them (i.e., solder does not adhere to the solder mask 120), those areas facilitate laser ablation to trim the thermistor resistance value without interference from the uneven solder surface. The solder mask 120 may be applied, for example, with a screen, such that the solder mask 120 has a uniform thickness over the contact 115 that facilitates laser ablation of the underlying contact 115. Consequently, automated trimming, rather than manual grinding, may be conducted after all the processes (e.g., contacting, soldering) that affect a thermal cycle of the thermistor 110 are completed.

FIG. 2 depicts a thermistor 110 according to an embodiment of the invention. In the exemplary embodiment shown in FIG. 2, the thermistor 110 has a cylindrical shape with a height of L and a diameter of the circular cross-sectional ends of D. The following is a discussion of adjusting resistance of the thermistor 110 according to one exemplary embodiment shown in FIG. 2. The thermistor 110 is for purposes of discussion disclosed to be 6 mm in diameter (D) (radius of 3 mm) and, therefore, presents a contact 115 surface area (A) of 28.27 mm² (Π*(D/2)²). By patterning one 0.5 mm×0.5 mm solder mask 120, for example, a 0.25 mm² area or an area of 0.88% of the contact 115 ((0.25/28.27)*100) would be masked. Ohm's law provides that:

R=L/A [EQ 1]

where R=resistance, L=distance between the contacts 115 (length of the cylindrical thermistor 110 in FIG. 2), and A=area of the surface of the contact 115, as discussed above.

Ablation of the contact 115 (at the masked area) reduces the area of the surface (A) covered by the contact 115 and, thereby, increases resistance (R) of the thermistor 110, because, as EQ 1 indicates, resistance (R) is inversely proportional to area (A). Non-masked areas of the contact 115, which may be covered by solder, are not ablated. Because the ablated spot is only on one side of the thermistor 110 (e.g., on the contact 115 visible in FIG. 2 and not the bottom of the cylinder, as well), only half of the total contact 115 surface is affected by ablation. That is, in the exemplary case, 0.44% resistance increase would be achieved by ablation. This illustrates how different numbers and sizes of the solder mask 120 may be used to achieve accurate resistance tuning. For example, if the mask 120 size were reduced beyond a 0.5 mm square, an even finer level of trimming could be achieved. In addition, incremental trimming (step adjustments in the resistance of the thermistor 110) is facilitated by sizing and patterning of the solder mask 120 or ablation pattern, because all of the unsoldered (masked) areas or area within the solder mask may not need to be ablated to achieve a desired calculated area (and resulting resistance). Although only the visible contact 115 (visible in FIG. 2) is discussed as having the solder mask 120 in the example above, both contacts 115 (one at each end of the cylindrical thermistor 110 shown in FIG. 2) may have a solder mask 120 applied and masked areas of contact 115 surfaces (on both ends) may be ablated to affect an increase in resistance value.

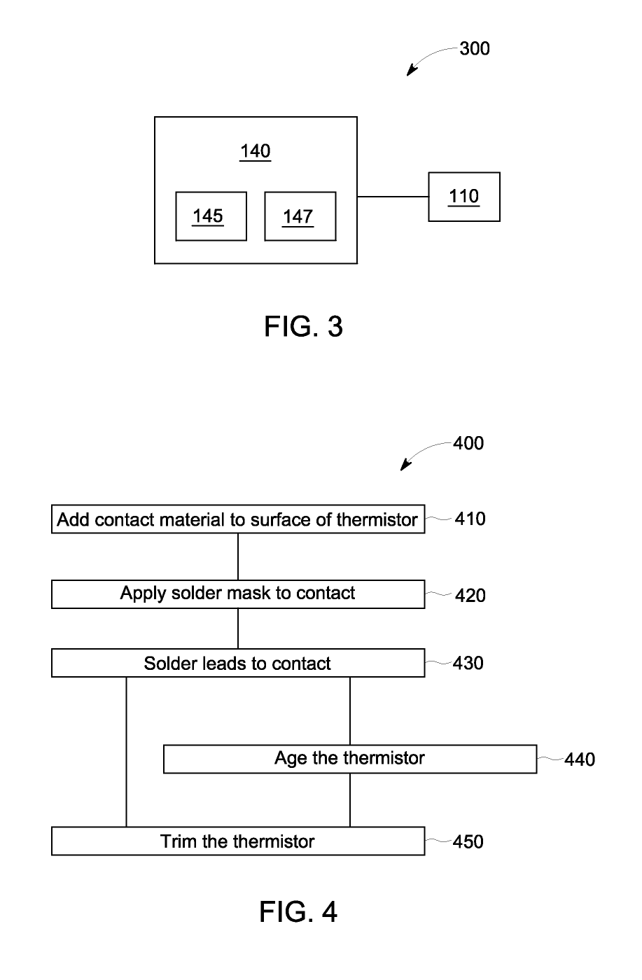

FIG. 3 is a block diagram of a system 300 to trim thermistor 110 resistance according to an embodiment of the invention. The system 300 includes the thermistor 110 according to embodiments such as those described with reference to FIGS. 1 and 2, for example. The system 300 also includes a controller 140 with one or more processors 145 and one or more memory devices 147. The automated laser ablation of the contact 115 surface of the thermistor 110, as described with reference to FIGS. 1 and 3, may be controlled by the controller 140. The controller 140 may also control the disposition of the contact 115 and the solder mask 120.

FIG. 4 depicts aspects of a process 400 to trim thermistor 110 resistance. At block 410, adding the contact 115 material to the surface of the thermistor 110 (coating the surface) facilitates soldering of the leads 130 to the thermistor 110 at the contact 115. At block 420, applying a solder mask 120 to the contact 115 is performed. As shown in FIG. 1, the solder mask 120 may be applied in a geometric pattern that repeats on the contact 115. Although a repeating pattern of squares is shown in FIG. 1, another shape may be repeated in a pattern (e.g., set of circles, concentric circles, rectangles) or a pattern may not be used at all, as shown in FIG. 2. Based on applying the solder mask 120, the contact 115 includes both exposed areas (areas of the contact 115 without the solder mask 120) and masked areas (areas of the contact 115 with the solder mask 120 applied), whether or not those areas are in any particular pattern, in order to facilitate soldering of the leads 130 and also facilitate completion of the process 200 to trim the thermistor 110 by an automated laser ablation technique. Soldering the leads 130 to the contact 115 in done in exposed areas of the contact 115 at block 430. Once the soldering is completed, the process 400 may include aging the thermistor 110, as needed, at block 440 to allow the resistance characteristic of the thermistor 110 to stabilize after the thermal cycle created by the soldering. At block 450, trimming the thermistor 110 includes performing laser ablation in the masked areas of the contact 115 where the contact 115 is not covered by solder.

FIGS. 5-7 illustrate exemplary solder mask 120 areas according to embodiments of the invention. In FIG. 5, a pattern of concentric circles of solder mask 120 are shown. In FIG. 6, a pattern of circular solder mask 120 areas is shown. In FIG. 7, the contact 115 material (shown as a rectangular cross-section) is covered by two solder mask 120 areas that do not form any pattern. The contact 115 surface and underlying ceramic or polymer block of the thermistor 110 are not limited to the shapes shown herein.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms.

It will be recognized that the various components and technologies may provide certain necessary or beneficial functionality or features. Accordingly, these functions and features as may be needed in support of the appended claims and variations therefore, are recognized as being inherently included as a part of the teachings herein and a part of the invention disclosed.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of constructing a thermistor, the method comprising:
coating a surface of a semiconductor substrate with contact material;
applying a solder mask on the contact material, the applying including applying the solder mask to one or more portions of the contact material to leave an exposed area without the solder mask and a masked area with the solder mask; and
trimming the contact material at the masked area to adjust a resistance of the thermistor.

2. The method according to claim 1, further comprising:
soldering the exposed area of the contact material to attach leads to the thermistor.

3. The method according to claim 1, wherein the trimming the contact material is achieved through a laser ablation process.

4. The method according to claim 3, further comprising controlling the laser ablation process to do step adjustment of the resistance.

5. The method according to claim 1, wherein the applying the solder mask includes applying the solder mask as a geometric shape in a repeated pattern over the contact material.

6. The method according to claim 1, wherein the applying the solder mask includes applying the solder mask as a square shape in a repeated pattern over the contact material.

7. The method according to claim 1, wherein the applying the solder mask includes applying the solder mask as a circular shape in a repeated pattern over the contact material.

8. The method according to claim 1, wherein the applying the solder mask includes applying the solder mask to the one or more areas of the contact material in an irregular pattern.

9. A thermistor, comprising:
a substrate;
a contact coating a surface of the substrate; and
a solder mask covering a portion of the contact to form a masked area and an unmasked area on the contact.

10. The thermistor according to claim 9, wherein the substrate is formed as a block.

11. The thermistor according to claim 10, wherein the substrate is formed as a cylinder.

12. The thermistor according to claim 9, wherein the masked portion is formed as a pattern of squares of the solder mask over the contact.

13. The thermistor according to claim 9, wherein the masked portion is formed as a pattern of concentric circles of the solder mask over the contact.

14. The thermistor according to claim 9, wherein the masked portion is formed as an irregular pattern over the contact.

15. The thermistor according to claim 9, further comprising solder covering the unmasked area of the contact, wherein the solder is configured to attached one or more leads to the contact.
